(19) United States
(12) Patent Application Publication
(10) Pub. No.: US 2026/0008012 A1
(43) Pub. Date: Jan. 8, 2026

(54) Catalysts for Reducing Methane Slip and Methods and Exhaust Systems Using the Same

(71) Applicant: His Majesty the King in Right of Canada as Represented by the Minister of Natural Resources, Ottawa (CA)

(72) Inventors: Gianni Caravaggio, Ottawa (CA); Lioudmila Nossova, Ottawa (CA)

(21) Appl. No.: 19/259,450

(22) Filed: Jul. 3, 2025

Related U.S. Application Data
(60) Provisional application No. 63/667,733, filed on Jul. 4, 2024.

(51) Int. Cl. B01D 53/94; B01J 21/04; B01J 23/42; B01J 23/44; B01J 23/63; B01J 35/61

(52) U.S. Cl. CPC B01D 53/94; B01J 21/04; B01J 23/42; B01J 23/44; B01J 23/63; B01J 35/615; B01D 2257/7025; B01D 2258/018

(57) ABSTRACT

Provided herein are methane oxidation catalysts and methods of using said methane oxidation catalysts to reduce methane in a gas stream comprising methane and sulfur. Select methods of the present disclosure comprise contacting the gas stream with a methane oxidation catalyst comprising a support comprising alumina doped with ceria, with platinum and palladium as active phases. The platinum and the palladium may comprise from about 1 wt % to about 10 wt % of the methane oxidation catalyst. The methane oxidation catalysts, methods and uses of the same may in selected embodiments exhibit improvements in resistance to sulfur poisoning over the prior art.

### RELATED APPLICATIONS

This application claims priority to U.S. Provisional Application No. 63/667,733, filed on Jul. 4, 2024, which is hereby incorporated by reference in its entirety.

### TECHNICAL FIELD

The present disclosure pertains generally to oxidation catalysts for reducing or removing components of a gas stream. More particularly, the present disclosure relates to catalysts, and methods, uses, and systems using the same, for reducing methane in a gas stream.

### BACKGROUND

Methane is a potent GHG that has about an 86 times greater greenhouse gas (GHG) impact compared to CO₂ for 20 years after emission. Methane is produced or released from a variety of sources including natural sources, waste sources, fossil fuels, and agricultural sources. Generally, methane is difficult to oxidize, since the methane molecule is highly stable due to the strong C—H bonds that prevent its low-temperature oxidation. Generally, the reduction of methane from various sources prior to its release into the atmosphere is desirable to mitigate GHG impacts. One such source is the combustion of natural gas. Fossil fuels such as natural gas consist mostly of methane.

Natural gas is a hydrocarbon fuel of choice for the transition towards a zero-carbon economy. Natural gas is abundant and is a relatively inexpensive fuel source that is widely used in heating and electricity production and has also received increased interest of late as a fuel for the transportation sector. For instance, lean burn natural gas engines have been shown to be similar in performance to diesel engines and can be used in a wide variety of transportation applications, such as light and medium duty vehicles, vocational and long-haul trucks and ships.

Natural gas engines, particularly lean burn natural gas engines, offer a relatively cleaner alternative than diesel and gasoline engines in that they produce approximately 20 to 25% less GHGs on a life-cycle basis due to the lower carbon content in methane. However, lean burn natural gas engines suffer from high levels of unburned methane in the exhaust. Methane requires a higher temperature to achieve combustion than conventional fuels, and thus cold spots or dead volumes in an engine cylinder can lead to incomplete combustion. It is therefore desirable for this unburned methane (also referred to as methane slip) to be eliminated due to the potency of methane as a GHG which can negate the natural gas engine's GHG benefit.

The use of catalysts to enable low-temperature oxidation of unburned methane is a possible approach to reduce methane slip. Although this approach has been tried in the past, such as in conjunction with lean burn natural gas engines, a commercially satisfactory solution has not yet shown to be available.

Under certain conditions, it may be possible to calibrate engine combustion to meet methane emission targets, but this often results in reduced engine performance or efficiency. Engine calibration to reduce methane slip can come at the expense of impacting the engine efficiency and other regulated emissions (e.g. NOx) adversely. Additionally, many catalysts are rapidly deactivated in the presence of gaseous water and sulfur containing species (sulfur), and therefore may not meet industry durability requirements for use in natural gas vehicles or in other applications such as in a gas compressor, natural gas boiler, natural gas furnace, natural gas power plant, in a gas stream resulting from mining activities, or the like. Furthermore, many catalysts that have been developed to reduce methane slip are not resistant to thermal and/or hydrothermal aging. As such, new catalysts and methods of using such catalysts are needed that address the shortcomings of previously tried approaches. Additionally new methods, uses, catalysts, and systems are needed to remove methane from a variety of gas streams.

### SUMMARY

The present disclosure relates to a methane oxidation catalyst, methods, uses, and exhaust systems comprising said catalyst, useful to remove methane from a gas stream or a volume of gas.

According to one exemplary embodiment, there is provided a method for reducing unburned methane in an exhaust gas stream.

According to a further exemplary embodiment, there is provided a method for reducing methane content in a gas stream comprising methane and sulfur, the method comprising contacting the gas stream with a methane oxidation catalyst, the methane oxidation catalyst comprising a support comprising alumina doped with ceria, with platinum and palladium as active phases. In certain exemplary embodiments, the gas stream further comprises water or water vapour, or oxygen, or any combination thereof.

Further embodiments may pertain to the use of a methane oxidation catalyst to reduce methane content in a gas stream comprising sulfur, the methane oxidation catalyst comprising a support comprising alumina doped with ceria, with platinum and palladium as active phases. In select embodiments, the platinum and palladium are present at a Pt:Pd wt/w ratio from about 0.01:1 to about 10:1, and a specific surface area (BET surface area) of the support is at least 100 m²/g.

Yet still further embodiments pertain to a methane oxidation catalyst for reducing methane content in a gas stream comprising methane and sulfur, the methane oxidation catalyst comprising a support comprising alumina doped with ceria, with platinum and palladium as active phases, the platinum and the palladium comprising from about 1 wt % to about 10 wt % of the methane oxidation catalyst.

Further embodiments may pertain to an exhaust system for reducing unburned methane in an exhaust gas stream from a natural gas engine, the exhaust gas stream comprising methane and sulfur, the exhaust system comprising a catalytic converter fluidly connected to an exhaust port of the natural gas engine, the catalytic converter comprising a methane oxidation catalyst configured to contact the exhaust gas stream to produce a treated exhaust gas stream, the methane oxidation catalyst having a support, the support comprising alumina doped with ceria, with platinum and palladium as active phases, the catalytic converter having an output to release the treated exhaust gas stream. In select embodiments of such exhaust gas systems, the natural gas engine is a lean burn natural gas engine.

Many variations or alternatives to the select embodiments described above will become apparent from the following detailed description of the present disclosure.

### BRIEF DESCRIPTION OF THE DRAWINGS

FIG. 1 illustrates T50 values (temperature at 50% methane conversion) for fresh and aged example catalysts.

### DETAILED DESCRIPTION OF EXEMPLARY EMBODIMENTS

Embodiments disclosed herein are generally directed to a methane oxidation catalyst having a support comprising alumina doped with ceria with platinum and palladium as active phases. Such catalysts may be used to reduce the amount of methane in a gas stream, for instance from an exhaust gas stream resulting from methane combustion in the engine of a natural gas vehicle (NGV). Unburned methane remaining after combustion may be converted by methane oxidation catalysts of the present disclosure to carbon dioxide and water. As a result, an exhaust stream would have reduced levels of methane and therefore reduce greenhouse gas emissions and/or the potency of greenhouse gas emissions after contacting said catalyst compared to the gas stream prior to contacting said catalyst. Certain exemplary embodiments of the present disclosure may provide a methane oxidation catalyst for use in a NGV emission control system, the catalyst having enhanced resistance to deactivation in the presence of gaseous water and sulfur compounds and/or that display enhanced thermal stability.

The present disclosure further pertains to methods and uses of reducing methane in an exhaust gas stream or volume of gas. The term “gas stream” should be considered to encompass any volume of gas being either a static volume of gas or a gas stream that is in motion. Catalysts of the present disclosure may contact the gas stream in any manner and should not be limited only to flow of the gas in gas stream over and/or through the catalyst.

Methods, uses and exhaust systems described herein may be used in conjunction with a vehicle. The term “vehicle”, as used herein, it is meant to refer to any machine or device used as a transportation means over land, sea, air, or space. The vehicle may be for example a compressed natural gas (CNG) or liquid natural gas (LNG) vehicle. In certain embodiments, the vehicle may be powered by a lean burn engine. In a lean burn engine, excess air is introduced to the combustion chamber.

Select embodiments of the present disclosure relate to a method of contacting an exhaust gas stream with a catalyst that comprises a metal oxide support such as an alumina support that may comprise ceria. Alumina, also known as aluminium oxide, is a chemical compound of aluminium and oxygen with the chemical formula Al₂O₃. An example of an alumina support doped with ceria that may be used to prepare the catalyst is a Puralox™ SCFa165/Ce20 support from Sasol™. This support comprises aluminium oxide derived from the controlled activation of high-purity alumina hydrates such as high-purity boehmite (AlOOH) and bayerite Al(OH)₃. The Puralox™ SCFa165/Ce20 support comprises a generally white, free-flowing powder with high-purity and consistency, and comprises the following properties (provided by Sasol™) as shown in Table 1.

TABLE 1
Properties of Puralox ™ SCFa 165/Ce20 support.

| Property | Unit | Approximate Value |
|---|---|---|
| Al₂O₃ | [wt %] | 80 |
| Na2O | [wt %] | 0.002 |
| L.O.I. | [wt %] | 3 |
| CeO₂ | [wt %] | 20 |
| Loose bulk density | [g/l] | 600-800 |
| Particle size (d50) | [μm] | 30 |
| Surface area | [m²/g] | 160 |
| Pore volume | [ml/g] | 0.5 |
| Pore radius | [nm] | 8 |

The catalyst may also comprise a mixture of different support materials. The alumina may be gamma alumina. Supports of the present disclosure may be produced as co-products with synthetic linear alcohols (Ziegler method) or directly from aluminum metal (on-purpose route). Several production steps may be completed to produce the different alumina-based supports. For instance, a first step may involve production of an aqueous intermediate (alumina slurry), which is further tailored in subsequent processing steps.

The final crystalline phase and physical properties of the alumina depend on the physical properties of the starting material as well as the calcination process, if used. Typical calcination temperatures of the boehmite lie within about 600-1000° C. By applying such temperatures, the physically and chemically bound water is removed, transforming the hydrate into an oxide. High-temperature calcination leading to α-Alumina can also be applied.

In certain embodiments, the specific surface area (BET surface area) of the catalyst is at least 50 m²/g, at least 90 m²/g, at least 125 m²/g, at least 150 m²/g, at least 200 m²/g, at least 250 m²/g, or at least 300 m²/g. In further embodiments, the BET surface area may be at least about 400 m²/g or at least about at least 500 m²/g. In other embodiments, the BET surface area may range from about 90 m²/g to about 210 m²/g, from about 130 m²/g to about 190 m²/g, from about 145 m²/g to about 175 m²/g, or about 160 m²/g. Catalysts of the Sasol Puralox SCFa series range from about 90 m²/g to about 210 m²/g.

A pore radius of select supports of the present disclosure may be at least about 2 Å, at least about 4 Å, at least about 6 Å, at least about 8 Å, at least about 12 Å, or at least about 15 Å. The pore radius may be about 4-10 Å in select embodiments. The weight ratio of alumina to ceria (Al₂O₃:CeO₄ w/w ratio) may be about 1:1, 2:1, 3:1, 4:1, 5:1, 10:1, 15:1, 18:1, 20:1, 25:1, 50:1 or any value in between. In certain embodiments, the range may be from about 2:1 to about 6:1, or about 3:1 to about 5:1, or about 4:1. A pore volume of the support may be about 0.1 ml/g to about 2 ml/g, or from about 0.3 ml/g to about 1.5 ml/g, or from about 0.35 ml/g to about 0.65 ml/g, or about 0.5 ml/g. The dopant ceria may comprise about 7 wt %, 10 wt %, 15 wt %, 20 wt %, 25 wt %, 30 wt %, or 33 wt % of the support, or any value in between.

The term “dopant” or “doped” in the context of a doped alumina hydrate, alumina oxide, mixed alumina oxide, or calcined alumina support refers to the intentional introduction of an amount of one or more foreign atoms or molecules (dopant) into the alumina support material to alter or enhance the performance of a catalyst prepared therefrom. Dopants can be additives and/or replacements of the molecules in the support material. Dopants may alter or modify one or more structural properties (e.g. alter crystal structure, pore properties, surface area, active site availability or distribution etc.), electronic properties (e.g. alter band structure, introduce or alter electronic states, modify electronic reactivity etc.), and/or chemical properties (e.g. reaction profile, surface chemistry, ability to absorb/store/donate reactive groups) of said catalyst, thereby altering or improving its efficiency, selectivity, stability, durability, and/or resistance to poisoning/deactivation. Doping of a support/catalyst can allow for moderate changes (e.g. tuning) or potentially dramatic changes to catalytic properties. Dopants may include metals or non-metals. In certain embodiments, the dopant is a transition metal.

In select catalysts of the present disclosure, platinum and palladium may each be present in the catalyst at an amount effective for reducing the content of methane in an exhaust gas stream relative to the methane content prior to contacting the methane oxidation catalyst. The platinum and/or palladium comprise an active phase of the catalyst for such embodiments. The term “active phase” should be considered to encompass any component of a catalyst that is directly involved in the catalytic reaction.

The concentration of the platinum and palladium may be effective to reduce methane content in an exhaust gas stream resulting from methane combustion by at least 30%, at least 40%, at least 50%, at least 60%, at least 70%, at least 80%, at least 85%, at least 90%, at least 95%, at least 99%, or up to 100% of methane content. Certain embodiments may demonstrate a T₅₀ (temperature at 50% methane conversion) of 500° C. or less, or 450° C. or less, or 435° C. or less, or 420° C. or less, or 400° C. or less, or 350° C. or less after being aged for 40 h at 500° C. in simulated lean-burn NG engine exhaust. Examples of ranges of effective amounts of each active metal are set forth below. The precise amounts of platinum and palladium for obtaining enhanced methane conversion can be determined by the skilled person for instance with reference to the methodology set forth in the examples of the present disclosure.

In one embodiment, the platinum is present at a higher concentration in the catalyst than palladium. The relative abundance of platinum relative to palladium in catalysts of the present disclosure may be described as a weight ratio of platinum to palladium (Pt:Pd w/w ratio). For example, the platinum may be present in the catalyst at a weight ratio of greater than 1 compared to the weight of the palladium. In certain embodiments, the w/w ratio of Pt:Pd may be 10:1, 9:1, 8:1, 7:1, 6:1, 5:1, 4:1, 3:1: 2:1 or 1:0.01, or any range in between. In other embodiments, the platinum and palladium may be presently in nearly equal amounts and have a Pt:Pd w/w ratio of about 1:1. In other embodiments, the palladium may be present in a higher amount that the platinum and may have a Pt:Pd w/w ratio of or 0.1:1, 0.01:10, 0.1:5, 0.5:5, 1:5, 1:3, 1:2, or any ratio in between. In other embodiments, the range of w/w ratios of Pt:Pd can be from about 0.01:1 to about 10:1, or the Pt:Pd w/w ratio range is from 0.1:1 to 0.75:1, or from 1:1 to 6:1. In still other embodiments, the methane oxidation catalyst comprises from 1.5 wt % to 2.5 wt % Pd and from 3.5 wt % to 4.5 wt % Pt.

The abundance of the platinum and palladium active phases may be expressed as a weight percentage (wt %) of the total weight of the catalyst. In one embodiment, the platinum may present in the catalyst at a concentration of between 0.5 wt % and 10 wt %, or between 1 wt % and 8 wt %, or between 1.5 wt % and 6 wt %, or between 2.0 wt % and 5.5 wt %, or between 2.5 wt % and 5 wt % or between 3.0 wt % and 4.5 wt %.

In a further embodiment, the palladium is present in the catalyst at a concentration of between 0.5 wt % and 10 wt %, or between 0.5 wt % and 6 wt %, or between 0.5 wt % and 4 wt %, or between 0.5 and 3 wt %, or between 0.75 wt % and 3.5 wt % or between 1 wt % and 3 wt %, or about 1.5 wt %. The platinum and palladium may be present in any combination of the above-noted weight percentages.

Catalysts of the present disclosure may be prepared by any method known to those of skill in the art. A non-limiting example of a suitable method of preparing supported catalysts of the present disclosure is incipient wetness impregnation (IWI). According to this method, an active metal precursor is dissolved in an aqueous or organic solution. Then the metal-containing solution is added to a catalyst support and capillary action draws the solution into the pores. The catalyst can subsequently be dried and calcined to drive off volatile components within the solution, depositing the metal on the catalyst surface. The concentration profile of the impregnated compound depends on the mass transfer conditions within the pores during impregnation and drying.

Catalysts may also be prepared by the wet impregnation (WI) method. According to this method, the support powder is suspended in an excess of a solution containing one or more precursors and stirred for some time in order to fill the pores with the precursor solution. The pH of the impregnating solution can be adjusted to a basic pH, for example using a concentrated solution of ammonia, to provide electrostatic interaction between cationic metal species and negatively charged surface hydroxyls of the support. The catalyst is subsequently dried followed by calcination in air.

As noted, catalysts of the present disclosure can be prepared by any suitable method. However, the method of preparing the catalyst can impact the properties of the catalyst and can lead to improvements in the T₅₀ value. Thus, a method for preparation can be selected to achieve a desired T₅₀ value. In one non-limiting example, the catalyst is prepared by IWI and the metals are added sequentially. In such embodiment, the catalyst is dried and calcined between addition of metals. In yet a further embodiment, the catalyst is prepared by the IWI method and the platinum is added before palladium, or alternatively the palladium is added before the platinum. In another embodiment, the catalyst is prepared by WI and the metals are added simultaneously. Simultaneous addition may include dissolving the metals together and subsequently adding them to the support, followed by drying and calcination. Employing either of these methods can result in a catalyst, freshly tested, exhibiting a T₅₀ value that is below about 500° C. or less, or about 450° C. or less, or about 435° C. or less, or about 400° C. or less, or about 350° C. or less.

The methane oxidation catalyst may be used in the manufacture of a catalytic converter that is for use in connection with an exhaust system of a NGV such as a lean burn NGV, a gas compressor, a natural gas boiler, a natural gas furnace, a natural gas power plant, or the like. The catalytic converter may be produced by known methods or alternatively by methods not known at the time of the present disclosure. Without being limiting, the catalytic converter may be a two-way catalytic converter. Certain embodiments may pertain to exhaust systems comprising methane oxidation catalysts of the present disclosure, wherein the exhaust system may comprise a catalytic converter containing a methane oxidation catalyst of the present disclosure.

In certain embodiments related to an exhaust system, when the methane oxidation catalyst is in use, a gas stream resulting from natural gas combustion in a combustion chamber in a vehicle passes through the methane oxidation catalyst of the catalytic converter, thereby reducing its methane content. As a result, reduced concentrations of methane are emitted to the atmosphere from the exhaust, for instance as measured at the tail pipe of a natural gas-powered vehicle. A gas stream resulting from methane combustion in a natural gas engine will typically comprise at least sulfur and water or water vapor. Other components that may be present in the gas stream may include oxygen, carbon dioxide, carbon monoxide, nitric oxide, nitrogen dioxide, or any combination thereof, among others.

Select catalysts, methods, uses, and exhaust systems of the present disclosure are effective at removing methane from a gas stream comprising methane and sulfur. Such gas streams may also include oxygen, carbon dioxide, carbon monoxide, nitric oxide, and/or nitrogen dioxide in a variety of combinations, such as in the exemplary relative amounts listed in the following paragraphs, or in amounts similar to or different from the amounts used in testing of the working examples disclosed still further below in the “Examples” section. Such gas streams may further comprise any variety of other components in varying amounts. The skilled person would readily recognize that such gas streams may be the product of combustion of a hydrocarbon or hydrocarbon fuel such as natural gas or methane combustion, but alternatively could be produced from any potential source, such for example but not limited to agricultural sources, landfills or waste disposal sites such as waste incineration sites, or sources associated with fossil fuel extraction or processing. Select further sources of gas streams suitable for use with the methods, uses, systems, or catalysts of the present disclosure may include a gas compressor, a natural gas boiler, a natural gas furnace, a natural gas power plant, a gas stream resulting from mining activities, flaring of hydrocarbon gases such as natural gas in association with fossil fuel extraction, a natural gas engine, or a natural gas vehicle.

A gas stream comprising methane that may be suitable for treatment using methods, uses, exhaust systems, or catalysts of the present disclosure, such as a gas stream resulting from combustion of methane. Such gas streams may contain between 10 and 20,000 ppm of methane, between 100 and 10,000 ppm of methane, or between 200 and 5,000 ppm of methane. Certain embodiments of methods, uses, catalysts, and exhaust systems of the present disclosure are effective for oxidation of methane in such gas streams.

Certain catalysts, methods, uses, and exhaust systems of the present disclosure are effective for treating gas streams that further comprise oxygen, such as for example when oxygen comprises from about 3% to about 19% of the gas stream, or from 5% to 15%, or from 7% to 13% of the gas stream, or about 10% of the gas stream. The gas stream may comprise water and/or water vapour in varying amounts, such as for example from about 1% to about 20% water and/or water vapour, from about 3% to about 17% water and/or water vapour, from about 5% to about 10% water and/or water vapour, or about 10% water and/or vapour. Water and/or water vapour may be present individually or in any combination.

The sulfur content in the gas stream resulting from methane combustion may be between 1 ppm and 30 ppm sulfur, or between 3 ppm and 30 ppm sulfur, or between 5 ppm and 30 ppm sulfur or between 6 ppm and 30 ppm sulfur.

A gas stream resulting from combustion, including combustion of a fuel source comprising methane such as natural gas, may, at least in some embodiments, have a temperature of between 300° C. and 650° C. or between 400° C. and 600° C., or between 425° C. and 500° C. or about 500° C.

Gas streams suitable for treatment using methods, uses, catalysts, and exhaust systems of the present disclosure may comprise carbon dioxide, such as for example from about 1% to about 10% CO₂, from about 3% to about 8% CO₂, from about 4% to about 7% CO₂, or about 6% CO₂.

Accordingly, the presently disclosed methods, uses, exhaust gas systems, and/or catalysts may be useful for oxidation of methane in a wide variety of gas streams comprising methane. Such gas streams may further comprise sulfur in certain embodiments. In addition to methane and sulfur, gas streams suitable for use in accordance with the present disclosure may further contain oxygen, carbon dioxide, or water or water vapour, or any variety of other components in any combination. Such gas streams may be treated at a wide range of temperatures. Certain examples of gas streams suitable for treatment are illustrated below by way of the following examples of effective use of catalysts of the present disclosure.

### EXAMPLES

The following section contains various examples of catalysts of the present disclosure and methods and uses thereof. The examples herein should not be considered limiting in any way but rather are merely provided as an illustration of select embodiments of the present disclosure.

Table 2 below summarizes the composition of the exemplary methane oxidation catalysts used in the experimental examples disclosed herein and the notation used to refer to each catalyst composition throughout the example section. As indicated in Table 2, the tested catalysts comprise between about 3 wt % and 7 wt % of a combination of platinum and palladium, with the balance of the catalyst in each case comprising a ceria doped alumina support that is commercially available from Sasol™ with a trade name of Puralox™ SCFa 165/Ce20. The properties of this exemplary support are discussed above in Table 1.

TABLE 2
Composition of catalysts used in the following examples.

| | |
|---|---|
| Name of | Catalyst composition |

| Example | | | Total content of |
|---|---|---|---|
| Catalyst | Pd (wt %) | Pt (wt %) | noble metals (wt %) |
| CAT-7 | 1 | 6 | 7 |
| CAT-6 | 2 | 4 | 6 |
| CAT-5 | 5 | 0.5 | 5.5 |
| CAT-4 | 2 | 2 | 4 |
| CAT-3 | 2 | 1 | 3 |

### Example 1: Catalysts with Pd and Pt on a Ceria Doped Alumina Exhibit Effective Methane Conversion Before and After Aging

In the following examples, the exemplary catalysts listed in Table 2 above were synthesized using incipient wetness impregnation of a commercial ceria doped alumina (Puralox™ SCFa165/Ce20, Sasol™) using solutions of metal precursors and varying the weight % of metals and the ratios between them. Table 3 shows the results of testing for fresh and aged catalysts under simulated natural gas vehicle exhaust.

TABLE 3
T₅₀ values for fresh and aged CAT-3 to CAT-7 catalysts tested
for methane oxidation under the following conditions: 500 mL/min,
10% O₂, 10% H₂O, 6% CO₂, 1000 ppm CH₄, 10 ppm SO₂, balance N₂.
Aged catalysts were aged at 500° C. for 40 hours.

| | T₅₀ (° C.) | | Methane conversion |
|---|---|---|---|
| | | Aged 40 h | after 40 h at 500° C. |
| Catalyst | Fresh | at 500° C. | (%) |
| CAT-7 | 363 | 432 | 70 |
| CAT-6 | 352 | 420 | 71 |
| CAT-5 | 367 | 484 | 32* |
| CAT-4 | 373 | 454 | 60 |
| CAT-3 | 385 | 485 | 38 |

*This value was corrected following the filing of US 63/667,733 to address a technical issue.

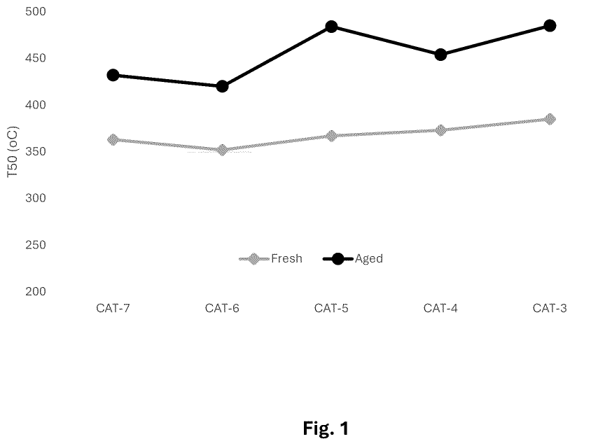

The results above are further illustrated in FIG. 1 which shows T₅₀ values for fresh and aged CAT-3 to CAT-7 catalysts tested for methane oxidation under the following conditions: 500 mL/min, 10% O₂, 10% H₂O, 6% CO₂, 1000 ppm CH₄, 10 ppm SO₂, balance N₂. Aged catalysts were aged at 500° C. for 40 hours.

As illustrated in Table 3 and FIG. 1, all the catalysts tested in the examples demonstrated 50% methane conversion below 500° C., which is in the range of lean burn natural gas engines conditions. CAT-6 demonstrated the highest activity with a T₅₀ value for the fresh catalyst of only 352° C. All of the catalysts tested demonstrated T₅₀ values for fresh catalyst between 352° C. and 385° C.

All of the tested catalysts also demonstrated resistance to deactivation by water and to sulfur poisoning. CAT-6, which comprises 2 wt % palladium and 4 wt % platinum, demonstrated the highest activity and stability for methane oxidation, exhibiting a T₅₀ of 420° C. after being aged for 40 h at 500° C. in simulated lean-burn NG engine exhaust. Other catalysts (CAT-3-CAT-5, CAT-7) also demonstrated considerable methane reduction activity after aging exhibiting T₅₀s below 500° C.

The redox properties of ceria make it an excellent catalyst for methane oxidation. Ceria has high oxygen storage capacity due to its ability to easily switch between Ce⁴⁺ and Ce³⁺ oxidation states. During methane oxidation, ceria can absorb and release oxygen from its lattice, providing oxygen species necessary for the reaction to proceed more easily. Thus, the ability of ceria to easily exchange oxygen atoms with the environment promotes catalytic activity.

All values stated herein are merely exemplary and may be considered approximations that can vary reasonably above and below the stated value. Additionally, all ranges stated herein are meant to encompass any and all values within the stated range. In certain cases, stated ranges may encompass values outside of the stated range.

It is understood that the above information merely describes select embodiments and examples of the catalysts, methods, uses, and exhaust systems of the present disclosure. It is well understood by the skilled person that innumerable variations of the above may be encompassed within the inventive concept of the present disclosure. It will also be apparent to persons skilled in the art that a number of variations and modifications can be made without departing from the scope of the invention as defined in the claims.

1. A method for reducing methane content in a gas stream from a lean burn NG engine comprising methane and sulfur, the method comprising:
contacting the gas stream with a methane oxidation catalyst, the methane oxidation catalyst comprising a support comprising alumina doped with ceria, with platinum and palladium as active phases.

2. The method according to claim 1, wherein the gas stream further comprises water or water vapour.

3. The method according to claim 1, wherein the platinum and palladium are present at a Pt:Pd w/w ratio from about 0.01:1 to about 10:1.

4. The method according to claim 1, wherein the platinum and the palladium comprise from about 1 wt % to about 10 wt % of the methane oxidation catalyst.

5. The method according to claim 1, wherein the gas stream further comprises oxygen.

6. The method according to claim 1, wherein a BET surface area of the support is at least 50 m²/g, at least 90 m²/g, at least 120 m²/g, at least 150 m²/g, at least 180 m²/g, or at least 200 m²/g.

7. The method according to claim 6, wherein the BET surface area is at least about 100 m²/g after calcination of the methane oxidation catalyst at about 550° C. for at least about 180 minutes or at least about 300 minutes.

8. The method according to claim 1, wherein the Pt:Pd w/w ratio range is from 0.1:1 to 0.75:1, or from 1:1 to 6:1.

9. The method according to claim 1, wherein the active phases of the methane oxidation catalyst comprise about:
6 wt % Pt and 1 wt % Pd;
4 wt % Pt and 2 wt % Pd;
0.5 wt % Pt and 5 wt % Pd;
2 wt % Pt and 2 wt % Pd; or
1 wt % Pt and 2 wt % Pd.

10. The method according to claim 1, wherein the support comprises alumina doped with ceria in an Al₂O₃:CeO₂ w/w ratio from about 3:1 to about 5:1.

11. The method according to claim 1, wherein the gas stream:
has a temperature of between 300° C. and 650°;
comprises between 10 and 20,000 ppm of methane;
comprises from about 3% to about 19% oxygen;
comprises from 1% to about 20% of the water or the water vapour; or
comprises from about 1% to about 10% CO₂;
or any combination thereof.

12. The method according to claim 1, wherein the methane oxidation catalyst has a T₅₀ of less than about 500° C., less than about 450° C., less than about 425° C., or less than about 400° C. after use in the gas stream for 40 h at a temperature of 500° C.

13. The method of claim 1, wherein the gas stream comprises exhaust from natural gas combustion.

14. The method of claim 13, wherein the natural gas combustion occurs in a lean burn natural gas engine natural gas engine.

15. The method of claim 14, wherein the lean burn natural gas engine is in a vehicle.

16. The method according to claim 15, wherein the methane oxidation catalyst comprises from 1.5 wt % to 2.5 wt % Pd and from 3.5 wt % to 4.5 wt % Pt, and wherein the methane oxidation catalyst contacts the gas stream in a catalytic converter fluidly connected to the lean burn natural gas engine of the vehicle.

17. The method according to claim 1, wherein the methane oxidation catalyst has a methane conversion rate of at least 30%, at least 40%, at least 50%, at least 60%, at least 70%, at least 80%, at least 85%, at least 90%, at least 95%, or greater than 99% after 40 hours of aging at 500° C.

18. Use of a methane oxidation catalyst to reduce methane content in a gas stream comprising sulfur, the methane oxidation catalyst comprising a support comprising alumina doped with ceria, with platinum and palladium as active phases, wherein the platinum and palladium are present at a Pt:Pd w/w ratio from about 0.01:1 to about 10:1, and wherein a BET surface area of the catalyst is at least 50 m²/g, at least 90 m²/g, at least 120 m²/g, at least 150 m²/g, at least 180 m²/g, or at least 200 m²/g.

19. A methane oxidation catalyst for reducing methane content in a gas stream comprising methane and sulfur, the methane oxidation catalyst comprising a support comprising alumina doped with ceria, with platinum and palladium as active phases, the platinum and the palladium comprising from about 1 wt % to about 10 wt % of the methane oxidation catalyst.

20. The methane oxidation catalyst according to claim 19, wherein the methane oxidation catalyst is comprised in a catalytic converter of an exhaust system for a natural gas engine.
